(19) United States
(12) Patent Application Publication
(10) Pub. No.: US 2004/0238780 A1
(43) Pub. Date: Dec. 2, 2004

(54) Control valve with integrated hardened valve seat

(76) Inventors: Doug P. Gethmann, Gladbrook, IA (US); Michael W. McCarty, Marshalltown, IA (US); Chad Engle, Marshalltown, IA (US); William E. Wears, Marshalltown, IA (US); Paul M. Gassman, Marshalltown, IA (US); Michael McRoberts, Ames, IA (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/452,628

(22) Filed: Jun. 2, 2003

(51) Int. Cl. F16K 1/00

(52) U.S. Cl. 251/359

(57) ABSTRACT

A control valve includes a valve body fabricated from a first metallic material, a flow passage formed through the valve body, a valve plug movable within the flow passage between an open and a closed position, and a valve seat within the flow passage. The valve seat is fabricated from a second metallic material having at least one physical characteristic different from that of the first metallic material, and is integrally formed with the valve body.

### FIELD OF THE INVENTION

The invention is generally related to flow control valves, and more particularly to a control valve with an integrated hardened valve seat and to a method of manufacturing the control valve with the hardened valve seat.

### BACKGROUND OF THE INVENTION

Many different control valve types and configurations are known. A typical control valve has a valve body and a valve plug that is movable within a flow passage of the body between open and closed positions. The valve plug typically bears against a valve seat that is supported by a part of the valve body within the flow passage when in a closed position.

A typical valve seat for such valves is manufactured from a steel material and suitably hardened for improved wear properties (e.g., abrasion resistance and cavitation resistance). A hardened valve seat can be inserted in the valve body in a number of different manners. For example, the hardened valve seat may be threadably attached to the valve body. However, using a separate hardened valve seat may make the control valve more prone to leakage, more expensive, and/or may create potential maintenance problems.

### BRIEF DESCRIPTION OF THE DRAWINGS

Exemplary control valves and methods of manufacturing such valves in accordance with the teachings of the present invention are described and explained in greater detail below with the aid of the drawing figure in which:

FIG. 1 is a cross-sectional view of a control valve in accordance with the invention.

### DETAILED DESCRIPTION OF THE PREFERRED EMBODIMENTS

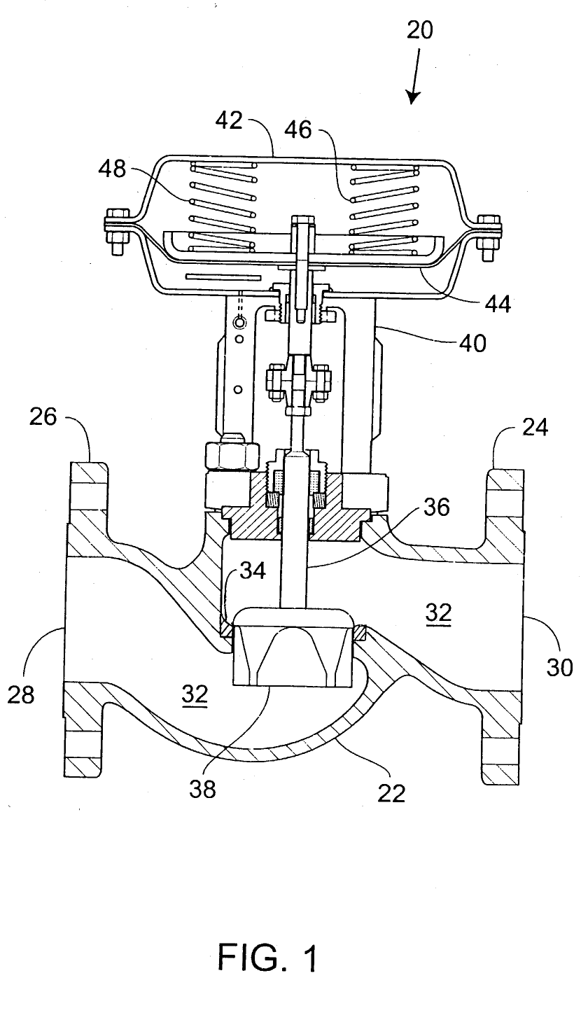

FIG. 1 shows a fluid control valve, generally indicated at 20 having a valve body 22 that may be fabricated from a first metallic material, such as, for example, ASTM A216 WCC carbon steel, 316L steel, Alloy 20, Hastalloy C steel, Duplex steel, or 304L steel. The valve body includes opposite mounting flanges 24, 26 for mounting the fluid control valve 20, for instance, in a pipeline system. The valve body 22 also includes a fluid inlet 28 and a fluid outlet 30 with a passageway 32 communicating therebetween.

A valve seat 34 is provided in the passageway for controlling the fluid flow through the fluid control valve 20 in response to the position of a valve operating member such as a valve stem 36 having a valve plug 38 at one end for sealing engagement with the valve seat 34. The valve seat 34 may be fabricated from a second metallic material having at least on physical characteristic that differs from that of the first metallic material that is used to fabricate the valve body 22. For example, the valve seat 34 may be formed from tungsten carbide steel, Alloy 6, Nitronic® 50/60 steel, 316L steel, nitride, melonite, or Ultimet® alloy (or another metallic material having greater hardness than the first metallic material that is used to fabricate the valve body 22).

The fluid control valve 20 includes a yoke 40 for connecting the valve body 22 to an actuator housing 42 that contains a diaphragm 44 connected to the valve stem 36.

As will be recognized by one skilled in the art, the fluid valve control valve 20 depicted in FIG. 1 is a “fail close” valve, whereby the diaphragm 44 is biased downwardly by springs 46, 48. Thus, if air pressure is lost that would normally be used to provide air pressure below the diaphragm 44 in order to open the passage 32 to fluid flow, the springs 46 and 48 would bias the diaphragm 44 in the valve stem 36 downwardly as oriented in FIG. 1, thereby closing the passage 32 to fluid flow in the event of a loss of air pressure used to operate the fluid control valve 20.

The valve seat 34 may be formed simultaneously and integral with the valve body 22 during a bi-metal casting process. For example, a metal piece for the valve seat may be placed in a mold before pouring molten metal into the mold to form the valve body 22. An outer portion of the valve seat 34 will be melted and thus the valve seat 34 will be securely attached to the valve body 22. Another way to simultaneously form the valve seat 34 with the valve body 22 is to pour two types of molten metal for both the valve seat 34 and the valve body 22 into a mold at or near the same time such that the two types of molten metal meet in the vicinity of the valve seat 34. The valve seat 34 may be hardened via welding, laser cladding (e.g., by overlaying the surface of the valve seat with alloy 6, and then treating with a laser), or any other suitable technique.

Although certain manufacturing methods and control valves have been disclosed and described herein in accordance with the teachings of the present invention, the scope of coverage of this patent is not limited thereto. On the contrary, this patent covers all embodiments of the teachings of the invention fairly falling within the scope of the appended claims, either literally or under the doctrine of equivalents.

What is claimed is:

1. A control valve comprising:
a valve body fabricated from a first metallic material;
a flow passage formed through the valve body;
a valve plug movable within the flow passage between an open and a closed position; and
a valve seat within the flow passage and fabricated from a second metallic material having at least one physical characteristic different from that of the first metallic material, the valve seat being integrally formed with the valve body.

2. A control valve according to claim 1, wherein the at least one physical characteristic includes hardness.

3. A control valve according to claim 2, wherein the second metallic material has a greater hardness than the first metallic material.

4. A control valve according to claim 1, wherein the valve seat and the valve body are formed using a bi-metal casting process.

5. A control valve according to claim 1, wherein the valve seat is hardened.

6. A control valve according to claim 5, wherein the valve seat is hardened by welding.

7. A control valve according to claim 5, wherein the valve seat is hardened by laser cladding.

8. A method of making a control valve with an integrated hardened metal valve seat, the method comprising the steps of:
providing a mold cavity having a valve body forming section and a flow passage forming section, the mold cavity adapted for forming a valve body with a flow passage;
forming a first metal flow path into a portion of the valve body forming section and a second metal flow path into a portion of the flow passage forming section;
introducing a first metallic material into the first metal flow path;
introducing a second metallic material into the second metal flow path simultaneously with the introduction of the first metallic material utilizing a bi-metal casting process, such that the second metallic material forms a valve seat within a flow control part of the flow passage, the second metallic material having at least one physical characteristic different from that of the first metallic material; and
cooling the first and second metallic materials.

9. A method according to claim 8, wherein the second metallic material has a greater hardness than the first metallic material.

10. A method according to claim 8, further including a step of hardening the valve seat.

11. A method according to claim 10, wherein the step of hardening the valve seat includes welding.

12. A method according to claim 10, wherein the step of hardening the valve seat includes laser cladding.
